(19) United States
(12) Patent Application Publication
(10) Pub. No.: US 2008/0059223 A1
(43) Pub. Date: Mar. 6, 2008

(54) Electronic remittance advice file splitter

(76) Inventors: Allen Y. Lu, Pasadena, CA (US); Stefan Yap, Irvine, CA (US); James L. Lee, Pasadena, CA (US)

Correspondence Address: HICKMAN PALERMO TRUONG & BECKER, LLP;AND SUN MICROSYSTEMS, INC., 2055 GATEWAY PLACE, SUITE 550, SAN JOSE, CA, 95110-1089, US

(21) Appl. No.: 11/513,573

(22) Filed: Aug. 30, 2006

(51) Int. Cl. G06Q 10/00; G06Q 40/00; G07F 19/00

(52) U.S. Cl. 705/2; 705/4; 705/30

(57) ABSTRACT

An electronic remittance file splitter automatically separates the line items from a remittance file that includes payments for claims originating from two different systems, based on a business rule associated with the two systems. Once the original remittance file is separated into two respective files that contain the line items associated with claims originating from each respective system, then two corresponding remittance files are generated in the appropriate format, such as the format for an HIPAA 835 ERA file. According to one embodiment, the two new files are reconciled against the original file. If the new files are accurate, then the new files are routed to the respective systems with which they are associated, so that each system can process the electronic remittances accordingly.

### BACKGROUND

As health care provider organizations, such as hospitals and medical groups, migrate from one billing/collections system to another, billing claims will often be generated from both billing/collections systems (generally, “accounting systems”). This is because most organizations utilize a cutover date as a milestone at which to transition origination of claims from the old system to the new system, rather than performing a complete data migration data load from the old system into the new system. The system migration process may be based on a particular cutover date on which services started on or after that cutover date are processed by the new system while services started before that cutover date are processed by the old system. For example, a hospital stay that starts before the cutover date but lasts until after the cutover date would be processed entirely by the old system.

Hence, there are times when claims (i.e., transactions) are generated by two separate accounting systems for a given payor. That is, both the old and new systems generate separate claim statements to the same payor (e.g., an insurance company), such as statements that conform to the HIPAA (Health Insurance Portability and Accountability Act of 1996) 837 transaction format. In such a scenario, even though the payor receives two claim files from a given service provider, the payor typically remits a single electronic remittance file (i.e., a payment file) to the service provider for processing, e.g., a HIPAA electronic remittance advice (ERA) statement that conforms to the 835 electronic remittance format (hereinafter “835 ERA file”). The format for 835 ERA files is described in detail in a document from the ASC X12N Insurance Subcommittee entitled “National Electronic Data Interchange Transaction Set Implementation Guide, Health Care Claim Payment/Advice, 835” (hereafter “the 835 ERA specification”), the entire content of which is incorporated by reference in its entirety for all purposes as if fully set forth herein.

Generally Accepted Accounting Principles (GAAP) essentially requires the posting of payments for a corresponding claim to a corresponding system from which the claim originated. Current operations practice regarding processing an 835 ERA file that includes remittances (e.g., payments) for claims originating from multiple systems may follow one of two approaches. One approach involves the provider printing a report from the 835 ERA file and highlighting or otherwise distinguishing the remittances for claims from one system from the remittances for claims from the other system, e.g., based on the service date. The provider then manually posts the respective remittances to the appropriate accounting system. Another approach is for the provider to upload the single 835 ERA file into either of the two systems, by which the remittances for claims not originating from the system in which the 835 ERA file was uploaded are not recognized and a corresponding error report is generated. The provider then manually posts the remittances from the error report (e.g., information about the rejected payments) to the appropriate accounting system, i.e., the system in which the original 835 ERA file was not uploaded. It is noteworthy that both of the foregoing approaches involve manual or semi-manual processes, which are typically labor intensive and error prone.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

Techniques for processing electronic remittance files that include payments for claims originating from two different systems involve use of a “splitter”. In response to uploading such an electronic remittance file to the splitter, the splitter automatically separates the line items in the remittance file based on a business rule associated with the two systems. The business rule according to which the line items are separated is based on how the transition between the two systems occurred. For example, if the cutover for transitioning between the two systems was based on a calendar date, then the line items are separated based on the claims whose service start date occurred before the cutover date and the claims whose service start date occurred after the cutover date. Once the original remittance file is separated into two respective temporary files that contain the line items associated with claims originating from each respective system, then two corresponding remittance files are generated in the appropriate format, i.e., one remittance file for each respective system from which the claims originated. For example, the temporary files are appended with proper header and trailer information in order to conform to an applicable file specification, such as for an 835 ERA file.

According to one embodiment, the two new files are reconciled against the original file. For example, the number of line items, and/or the dollar amount associated with the transactions, and/or the number of patient accounts from the two new files are compared to the same information from the original file to determine whether or not the file separating process was performed accurately. Finally, the new files are routed to the respective systems with which they are associated so that each system can process the electronic remittance accordingly. Hence, use of the automated splitter avoids manual processing of an inbound 835 ERA file containing line items for transactions associated with claims from two different systems, as well as the associated labor costs, and reduces the possibility of errors associated with manually and semi-manually posting the content of the inbound 835 ERA file.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates the flow of an original EDI file through an electronic remittance file splitter tool, according to an embodiment of the invention;

FIG. 2 is a block diagram that illustrates functional components of an electronic file splitter tool, according to an embodiment of the invention;

FIG. 3 is a flow diagram that illustrates a process for managing electronic remittance files associated with health care provider claims, according to an embodiment of the invention; and

FIG. 4 is a block diagram that illustrates a computer system upon which an embodiment of the invention may be implemented.

### DETAILED DESCRIPTION OF EMBODIMENT(S)

In the following description, for purposes of explanation, numerous specific details are set forth in order to provide a thorough understanding of the present invention. It will be apparent, however, that the present invention may be practiced without these specific details. In other instances, well-known structures and devices may be shown in block diagram form in order to avoid unnecessarily obscuring the present invention.

### Electronic Remittance File Splitter

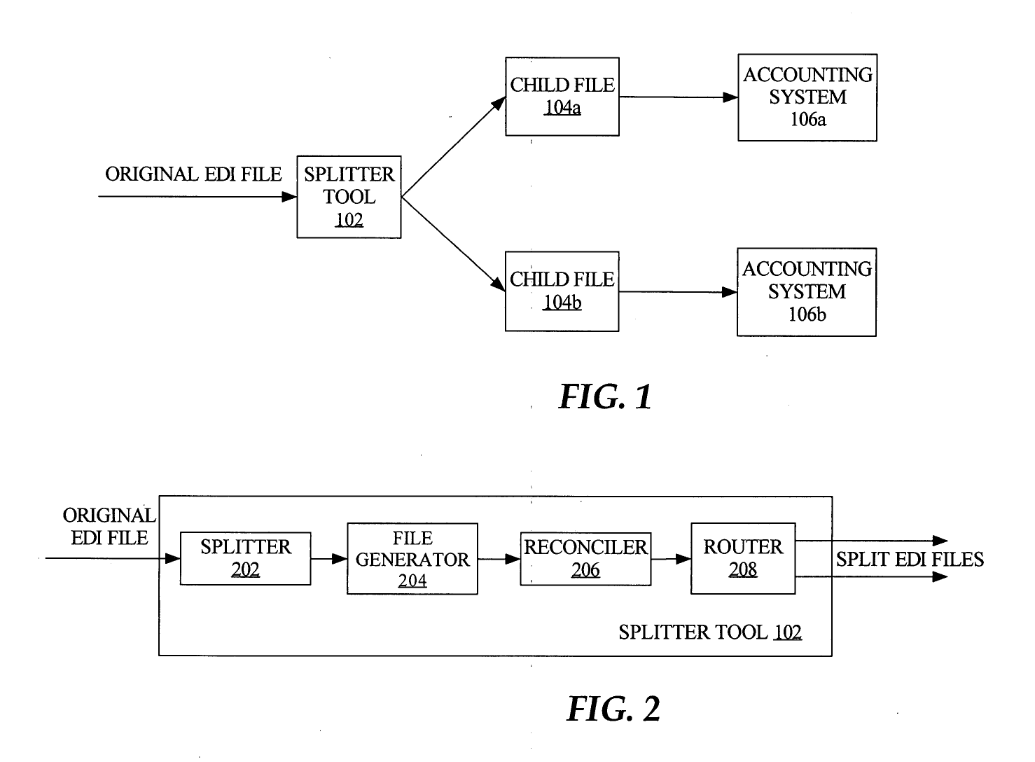

FIG. 1 is a block diagram that illustrates the flow of an EDI file through an electronic remittance file splitter tool, according to an embodiment of the invention. An electronic remittance file splitter tool (hereafter “splitter tool”) described herein provides an electronic gateway for processing inbound electronic remittance advice files, such as 835 ERA files, destined for multiple patient accounting systems used by the health care service provider, e.g., accounting software applications.

FIG. 1 depicts an original EDI (Electronic Data Interchange) file arriving at a splitter tool 102. An example of such an EDI file is an 835 ERA file. Splitter tool 102 generates multiple separate child files 104a, 104b based on the original file. For example, splitter tool 102 generates a separate child 835 ERA file for each of multiple accounting systems 106a, 106b, where each child 835 ERA file contains the line items for transactions involving claims generated from a respective accounting system 106a, 106b. Splitter tool 102 routes each respective child file 104a, 104b to its corresponding accounting system 106a, 106b, where the corresponding accounting system is the system from which claims corresponding to the line items were generated. According to one embodiment, child files 104a, 104b are reconciled against the original file prior to routing to the accounting systems 106a, 106b.

An example of the foregoing flow begins with a health care provider receiving an 835 ERA file from a payor, which had received billing claims from the provider from the first accounting system 106a and separate billing claims from the provider from the second accounting system 106b, where both the first and second accounting systems 106a, 106b produced claims for different healthcare services rendered during some period of time by the healthcare provider.

### Electronic Remittance File Splitter Components

FIG. 2 is a block diagram that illustrates functional components of an electronic file splitter tool 102, according to an embodiment of the invention. As depicted in FIG. 2, splitter tool 102 comprises a splitter 202, a file generator 204, a reconciler 206 and a router 208, all of which are described in greater detail hereafter.

Embodiments of the invention are described herein for purposes of example in the context of facilitating concurrent use of two accounting systems and, therefore, in the context of splitting an original file into two files that each corresponds to one of the two accounting systems. However, the techniques described herein can be implemented for use with any number of multiple accounting systems and corresponding split files. Therefore, embodiments are not limited to use in the strict context of two accounting systems and two corresponding split files. Furthermore, embodiments of the invention are described herein for purposes of example in the context of 835 ERA files. However, the techniques described herein can be implemented for use with other types of EDI files. Therefore, embodiments are not limited to use strictly with 835 ERA files.

### Splitter

In response to an original EDI file (“parent file”) being uploaded to the splitter tool 102, splitter 202 automatically splits the content of the parent file into two corresponding temporary files. The temporary files are generated by the splitter 202 by separating the line items for transactions associated with claims originating from an old accounting system (e.g., accounting system 106a of FIG. 1) from the line items for transactions associated with claims originating from a new accounting system (e.g., accounting system 106b of FIG. 1). The temporary files are generated by the splitter 202 according to a business rule relating to the manner in which a cutover date was implemented for transitioning from the old accounting system to the new accounting system. Hence, the splitter 202 may be configured with a rules evaluation engine or may call into a rules engine, e.g., external to splitter 102.

Non-limiting examples of data on which business rules may be based, for use in separating the line items from the original file (i.e., a “key”), include (a) the start date for a given health care service, such as the date a patient is admitted to a hospital or the date a patient receives outpatient services in a medical office; (b) the patient account number format, such as when different account number formats are associated with the old and new accounting systems; and (c) the facility at which the billing service was provided, such as when a group of health care facilities are incrementally migrated to a new accounting system rather than all at once.

Separating the line items from the original file involves reading each line item and processing the line item according to the appropriate business rule. As mentioned, each business rule is associated with a certain key (e.g., the service start date, patient account number, facility ID) for use in processing the line items from the original file. Hence, the precise location of the key in the line item (i.e., in the transaction line) is specified in the business rule so that the splitter can read and interpret the key value from the line item. The 835 ERA specification describes and specifies the location for each data field in a transaction line item in an 835 ERA file, e.g., by loop, segment, and field position. Thus, according to one embodiment, the business rule specifies the key location accordingly, by identifying the loop, segment and field position. Likewise, the splitter 202 is able to interpret the key location to identify the key value for any given transaction line item.

Once the splitter 202 locates the key value for a given line item, the splitter 202 applies logic defined in the corresponding business rule. For example, the logic of a business rule may state: for each line item, if the service start date (the key value) is before or on Aug. 1, 2006 (the cutover date), write the line item to temporary file A; else write the line item to temporary file B. For another example, the logic of another business rule may state: for each line item, if the patient account number (the key value) begins with an “H” (as with account numbers in the old system), write the line item to temporary file A; else if the patient account number begins with “I” (as with account numbers in the new system) write the line item to temporary file B. For a final example, the logic of another business rule may state: for each line item, if the facility at which the service was provided (the key value) is facility “A”, “B”, or “C” (as with facilities already transitioned to the new system), write the line item to temporary file A; else if the facility at which the service was provided is facility “D”, “E”, or “F” (as with facilities not yet transitioned to the new system) write the line item to temporary file B. The business rule is used to loop through each line item until the end of line items is reached.

Upon reaching the end of the line items from the original parent EDI file, every line item has been processed by splitter 202 and two temporary files now exist, where each respective temporary file includes line items for transactions involving claims originally generated by each respective accounting system, such as accounting systems 106a, 106b (FIG. 1).

### File Generator

File generator 204 automatically manipulates the temporary files generated by the splitter 202 to conform these files to the appropriate EDI document specification, such as the 835 ERA specification. According to one embodiment, the file generator 204 translates the temporary files into child files conforming to the same electronic file format to which the original EDI file conforms. Stated otherwise, if the original EDI file is an 835 ERA file, then the file generator 204 translates the temporary files into conforming 835 ERA files. For example, file generator 204 appends the appropriate envelope, functional group, and transaction set information (e.g., control structures as defined in the 835 ERA specification) to each of the temporary files, to conform them to the 835 ERA specification. Generally, envelope, functional group, and transaction set information include header and trailer type of information that describes particular 835 ERA files, such as the date and source of the file, and the like.

Upon the file generator 204 completing translation of the two temporary files into conformant child files (e.g., child files 104a, 104b of FIG. 1), the files are in condition for passing to the appropriate respective accounting system 106a, 106b (FIG. 1).

### Reconciler

According to one embodiment, the reconciler 206 automatically reconciles content from the child files against corresponding content from the original parent EDI file, to verify that the splitter 202 correctly translated the parent file into corresponding child files. According to various embodiments, the reconciler 206 compares one or more of the following data items to verify that the splitter 202 correctly processed the parent file: (a) the combined number of line items in the child files with the number of line items in the parent file; (b) the combined currency amount corresponding to all the line items in the child files with the currency amount corresponding to all the line items in the parent file; and/or (c) the number of patient accounts in the child files with the number of patient accounts in the parent file. Based on comparing any of the foregoing data items, the reconciler 206 either generates an error log (e.g., for resolution offline) indicating that errors occurred in splitting the parent file into corresponding child files, or indicates that the files are reconciled, i.e., that the parent file was correctly split. For an example of the latter, reconciler 206 sends a message to router 208 indicating in effect that the files passed the reconciliation process and are ready to be routed.

### Router

Upon successful reconciliation by reconciler 206, router 208 automatically routes the child files generated by file generator 204 to the corresponding accounting systems, so that each child file can be processed in a usual manner by each respective system. For example, router 208 routes child file 104a to accounting system 106a and child file 104b to accounting system 106b, as depicted in FIG. 1. One approach to routing the child files involves moving or copying each child file to an appropriate directory or folder associated with each respective accounting system. Upon routing to the appropriate accounting systems, the splitter process is complete for a given inbound EDI file.

### Managing Electronic Remittance Files

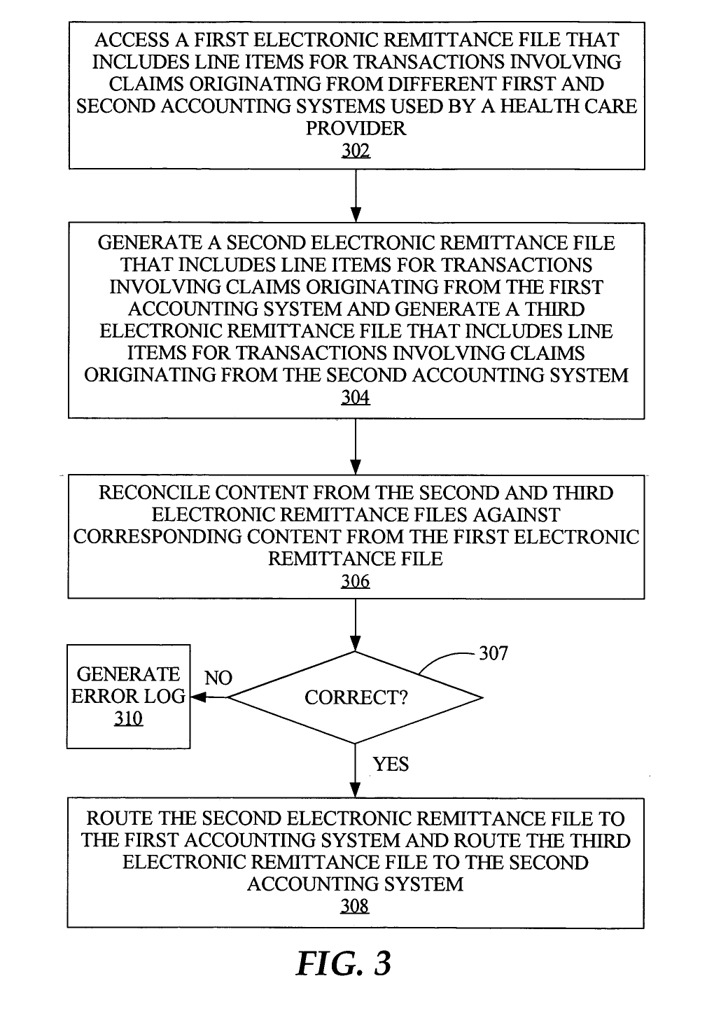

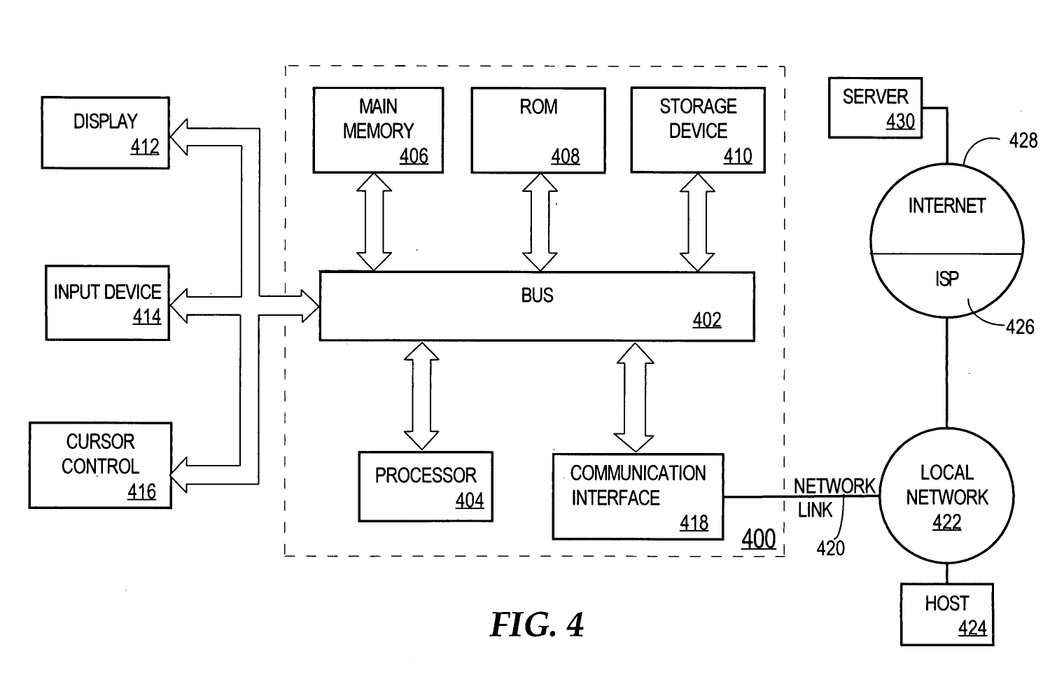

FIG. 3 is a flow diagram that illustrates a process for managing electronic remittance files associated with health care provider claims, according to an embodiment of the invention. According to one embodiment, the process illustrated in FIG. 3 is embodied in instructions which, when executed by one or more processors, cause performance of the method. For example, such instructions may be constituent to a computer program executed by the computer system 400 of FIG. 4, such as a computer program embodiment of splitter tool 102 (FIGS. 1 and 2).

At block 302, a first electronic remittance file is accessed, which includes line items for transactions involving claims originating from different first and second accounting systems used by a health care provider. For example, an inbound EDI file, such as an 835 ERA file, is uploaded or otherwise provided to the splitter tool 102.

At block 304, an electronic remittance file containing line items for transactions involving claims originating from the first accounting system, and an electronic remittance file containing line items for transactions involving claims originating from the second accounting system, are generated. For example, child file 104a (FIG. 1) and child file 104b (FIG. 1) are generated by operation of splitter 202 (FIG. 2) and file generator 204 (FIG. 2), as described herein in reference to FIG. 2. That is, splitter 202 generates temporary files by separating the line items associated with each respective accounting system, and file generator 204 adds the appropriate envelope, functional group, and transaction set information to conform those files to the appropriate format, such as the 835 ERA file format. Furthermore, the splitter 102 could be implemented to split the parent file into multiple child files for each corresponding accounting system, if desired.

At block 306, some content from the multiple child files are reconciled against some corresponding content from the parent file, to validate that the file splitter process operated accurately, as discussed in reference to reconciler 206 (FIG. 2). As discussed, embodiments can be implemented to reconcile one or more various parameters between the parent and child files, such as the number of line items, the currency amount or value of the line items, and/or the number of patient accounts, to ensure the accuracy of the child files before routing them to the respective accounting systems.

From decision block 307, if the child files are found to be correct based on the reconciliation performed at block 306, then each respective child file (conforming to the appropriate EDI format) is routed to the respective corresponding accounting system, at block 308. For example, child file 104a is routed to accounting system 106a (FIG. 1) and child file 104b is routed to accounting system 106b (FIG. 1), as described in reference to router 208 (FIG. 2). Once received at each respective corresponding accounting system, the child files can be processed according to a typical procedure, in order to post the payments, adjustments, denials, etc. to the appropriate accounting systems. If, however, the child files are found to be incorrect based on the reconciliation performed at block 306, then an error log is generated at block 310. Thus, the error log can be used to resolve the errors associated with the child files, either manually or via an automated business process tool.

Therefore, automated techniques and systems are described for managing electronic remittance files associated with health care provider claims that are based on multiple accounting (e.g., billing/collections) systems used within a health care provider organization. Use of the automated techniques and systems described herein avoids manual or semi-manual processes for posting the payments, adjustments, denials, etc. from a single parent EDI file to multiple accounting systems, and avoids the associated labor costs and proneness for error.

### Hardware Overview

In one embodiment, the splitter 102 may take the form of sets of instructions that are executed by one or more processors. If they take the form of sets of instructions, FIG. 4 shows a block diagram of a computer system 400 upon which these sets of instructions may be executed. Hence, FIG. 4 is a block diagram that illustrates a computer system 400 upon which an embodiment of the invention may be implemented. Computer system 400 includes a bus 402 for facilitating information exchange, and one or more processors 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions by processor 404. Computer system 400 may further include a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

In computer system 400, bus 402 may be any mechanism and/or medium that enables information, signals, data, etc., to be exchanged between the various components. For example, bus 402 may be a set of conductors that carries electrical signals. Bus 402 may also be a wireless medium (e.g. air) that carries wireless signals between one or more of the components. Bus 402 may also be a medium (e.g. air) that enables signals to be capacitively exchanged between one or more of the components. Bus 402 may further be a network connection that connects one or more of the components. Overall, any mechanism and/or medium that enables information, signals, data, etc., to be exchanged between the various components may be used as bus 402.

Bus 402 may also be a combination of these mechanisms/media. For example, processor 404 may communicate with storage device 410 wirelessly. In such a case, the bus 402, from the standpoint of processor 404 and storage device 410, would be a wireless medium, such as air. Further, processor 404 may communicate with ROM 408 capacitively. In this instance, the bus 402 would be the medium (such as air) that enables this capacitive communication to take place. Further, processor 404 may communicate with main memory 406 via a network connection. In this case, the bus 402 would be the network connection. Further, processor 404 may communicate with display 412 via a set of conductors. In this instance, the bus 402 would be the set of conductors. Thus, depending upon how the various components communicate with each other, bus 402 may take on different forms. Bus 402, as shown in FIG. 4, functionally represents all of the mechanisms and/or media that enable information, signals, data, etc., to be exchanged between the various components.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

At this point, it should be noted that although the invention has been described with reference to a specific embodiment, it should not be construed to be so limited. Various modifications may be made by those of ordinary skill in the art with the benefit of this disclosure without departing from the spirit of the invention. Thus, the invention should not be limited by the specific embodiments used to illustrate it but only by the scope of the issued claims and the equivalents thereof.

What is claimed is:

1. A computer-implemented method for managing electronic remittance files associated with health care provider claims, comprising:
accessing a first electronic remittance file that comprises line items for transactions involving claims originating from both a first accounting system used by a health care provider and a second accounting system used by said health care provider; and
generating one or more second electronic remittance files and one or more third electronic remittance files based on said first remittance file, wherein said one or more second electronic remittance files comprise line items for transactions involving claims originating from said first billing and/or collections system and said one or more third electronic remittance files comprise line items for transactions involving claims originating from said second billing and/or collections system.

2. The method of claim 1, further comprising:
reconciling content from said second and third electronic remittance files with content from said first electronic remittance file.

3. The method of claim 2, wherein reconciling comprises:
comparing a number of line items in said second and third electronic remittance files with a number of line items in said first electronic remittance file; and
if said number of line items in said second and third electronic remittance files is not equal to the number of line items in said first electronic remittance file, then generating an error log indicating that said number of line items in said second and third electronic remittance files is not equal to the number of line items in said first electronic remittance file.

4. The method of claim 2, wherein reconciling comprises:
comparing a currency amount corresponding to said line items in said second and third electronic remittance files with a currency amount corresponding to said line items in said first electronic remittance file; and
if said currency amount corresponding to said line items in said second and third electronic remittance files is not equal to said currency amount corresponding to said line items in said first electronic remittance file, then generating an error log indicating that said currency amount corresponding to said line items in said second and third electronic remittance files is not equal to said currency amount corresponding to said line items in said first electronic remittance file.

5. The method of claim 2, wherein reconciling comprises:
comparing a number of patient accounts corresponding to said line items in said second and third electronic remittance files with a number of patient accounts corresponding to said line items in said first electronic remittance file; and
if said number of patient accounts corresponding to said line items in said second and third electronic remittance files do not match said number of patient accounts corresponding to said line items in said first electronic remittance file, then generating an error log indicating that said number of patient accounts corresponding to said line items in said second and third electronic remittance files do not match said number of patient accounts corresponding to said line items in said first electronic remittance file.

6. The method of claim 1, wherein said generating comprises:
separating, based on a business rule, said line items for transactions involving claims originating from said first accounting system from said line items for transactions involving claims originating from said second accounting system;
storing in a first temporary file said line items for transactions involving claims originating from said first accounting system and storing in a second temporary file said line items for transactions involving claims originating from said second accounting system;
adding interchange, functional group, and transaction set control structures to said first temporary file to generate said second electronic remittance file that complies with National Electronic Data Interchange Transaction Set Implementation Guide for Health Care Claim Payment/Advice 835 format; and
adding interchange, functional group, and transaction set control structures to said second temporary file to generate said third electronic remittance file that complies with said National Electronic Data Interchange Transaction Set Implementation Guide for Health Care Claim Payment/Advice 835 format.

7. The method of claim 1, wherein said generating comprises:
separating, based on patient account numbers associated with said line items from said first electronic remittance file, said line items for transactions involving claims originating from said accounting system from said line items for transactions involving claims originating from said second accounting system.

8. The method of claim 1, wherein said generating comprises:
separating, based on service start dates associated with said line items from said first electronic remittance file, said line items for transactions involving claims originating from said first accounting system from said line items for transactions involving claims originating from said second accounting system.

9. The method of claim 1, wherein said generating comprises:
separating, based on facilities at which services associated with said line items from said first electronic remittance file are rendered, said line items for transactions involving claims originating from said first accounting system from said line items for transactions involving claims originating from said second accounting system.

10. The method of claim 1, further comprising:
routing said one or more second electronic remittance files to said first accounting system; and
routing said one or more third electronic remittance files to said second accounting system.

11. A machine-readable medium storing instructions which, when executed by one or more processors, cause performance of:
accessing a first electronic remittance file that comprises line items for transactions involving claims originating from both a first accounting system used by a health care provider and a second accounting system used by said health care provider; and
generating one or more second electronic remittance files and one or more third electronic remittance files based on said first remittance file, wherein said one or more second electronic remittance files comprise line items for transactions involving claims originating from said first billing and/or collections system and said one or more third electronic remittance files comprise line items for transactions involving claims originating from said second billing and/or collections system.

12. The machine-readable medium of claim 11, said instructions comprising instructions which, when executed by said one or more processors, cause performance of:
reconciling content from said second and third electronic remittance files with content from said first electronic remittance file.

13. The machine-readable medium of claim 12, wherein instructions causing reconciling comprise instructions which, when executed by said one or more processors, cause performance of:
comparing a number of line items in said second and third electronic remittance files with a number of line items in said first electronic remittance file; and
if said number of line items in said second and third electronic remittance files is not equal to the number of line items in said first electronic remittance file, then generating an error log indicating that said number of line items in said second and third electronic remittance files is not equal to the number of line items in said first electronic remittance file.

14. The machine-readable medium of claim 12, wherein instructions causing reconciling comprise instructions which, when executed by said one or more processors, cause performance of:
comparing a currency amount corresponding to said line items in said second and third electronic remittance files with a currency amount corresponding to said line items in said first electronic remittance file; and
if said currency amount corresponding to said line items in said second and third electronic remittance files is not equal to said currency amount corresponding to said line items in said first electronic remittance file, then generating an error log indicating that said currency amount corresponding to said line items in said second and third electronic remittance files is not equal to said currency amount corresponding to said line items in said first electronic remittance file.

15. The machine-readable medium of claim 12, wherein instructions causing reconciling comprise instructions which, when executed by said one or more processors, cause performance of:
comparing number of patient accounts corresponding to said line items in said second and third electronic remittance files with number of patient accounts corresponding to said line items in said first electronic remittance file; and
if said number of patient accounts corresponding to said line items in said second and third electronic remittance files do not match said number of patient accounts corresponding to said line items in said first electronic remittance file, then generating an error log indicating that said number of patient accounts corresponding to said line items in said second and third electronic remittance files do not match said number of patient accounts corresponding to said line items in said first electronic remittance file.

16. The machine-readable medium of claim 11, wherein instructions causing generating comprise instructions which, when executed by said one or more processors, cause performance of:
separating, based on a business rule, said line items for transactions involving claims originating from said first accounting system from said line items for transactions involving claims originating from said second accounting system;
storing in a first temporary file said line items for transactions involving claims originating from said first accounting system and storing in a second temporary file said line items for transactions involving claims originating from said second accounting system;
adding interchange, functional group, and transaction set control structures to said first temporary file to generate said second electronic remittance file that complies with National Electronic Data Interchange Transaction Set Implementation Guide for Health Care Claim Payment/Advice 835 format; and
adding interchange, functional group, and transaction set control structures to said second temporary file to generate said third electronic remittance file that complies with said National Electronic Data Interchange Transaction Set Implementation Guide for Health Care Claim Payment/Advice 835 format.

17. The machine-readable medium of claim 11, wherein instructions causing generating comprise instructions which, when executed by said one or more processors, cause performance of:
separating, based on patient account numbers associated with said line items from said first electronic remittance file, said line items for transactions involving claims originating from said accounting system from said line items for transactions involving claims originating from said second accounting system.

18. The machine-readable medium of claim 11, wherein instructions causing generating comprise instructions which, when executed by said one or more processors, cause performance of:
separating, based on service start dates associated with said line items from said first electronic remittance file, said line items for transactions involving claims originating from said first accounting system from said line items for transactions involving claims originating from said second accounting system.

19. The machine-readable medium of claim 11, wherein instructions causing generating comprise instructions which, when executed by said one or more processors, cause performance of:
separating, based on facilities at which services associated with said line items from said first electronic remittance file are rendered, said line items for transactions involving claims originating from said first accounting system from said line items for transactions involving claims originating from said second accounting system.

20. The machine-readable medium of claim 11, said instructions comprising instructions which, when executed by said one or more processors, cause performance of:
routing said one or more second electronic remittance files to said first accounting system; and
routing said one or more third electronic remittance files to said second accounting system.
